(19) United States
(12) Patent Application Publication
(10) Pub. No.: US 2013/0003778 A1
(43) Pub. Date: Jan. 3, 2013

(54) METHOD FOR EVALUATING AN EXHAUST GAS TEMPERATURE IN A EXHAUST PIPE OF AN INTERNAL COMBUSTION ENGINE

(75) Inventors: Manuel TUGNOLO, Collegno (TO) (IT); Francesco CIANFLONE, Torino (TO) (IT)

(73) Assignee: GM GLOBAL TECHNOLOGY OPERATIONS LLC, Detroit, MI (US)

(21) Appl. No.: 13/533,536

(22) Filed: Jun. 26, 2012

(30) Foreign Application Priority Data
Jun. 28, 2011 (GB) 1111003.8

(51) Int. Cl. G01K 13/02

(52) U.S. Cl. 374/45; 374/E13.006

(57) ABSTRACT

A method for determining a value of an exhaust gas temperature in a predetermined position along an exhaust pipe of an internal combustion engine is provided. The method includes measuring a value of an exhaust gas temperature in the exhaust pipe with a temperature sensor and measuring a value of a pressure within a cylinder of the internal combustion engine with a pressure sensor. A value of an exhaust gas temperature in the exhaust pipe is estimated based on the measured pressure value. Whether the internal combustion engine is operating under a transient condition or not is detected. The value of the exhaust gas temperature in the predetermined position is determined based on the measured exhaust gas temperature value, if the transient condition is not detected. Otherwise, the value of the exhaust gas temperature in the predetermined position is determined based on the estimated exhaust gas temperature value.

### CROSS-REFERENCE TO RELATED APPLICATION

This application claims priority to British Patent Application No. 1111003.8, filed Jun. 28, 2011, which is incorporated herein by reference in its entirety.

### TECHNICAL FIELD

The technical field generally relates to a method for evaluating (determining a value of) an exhaust gas temperature in a predetermined position along an exhaust pipe of an internal combustion engine, typically an internal combustion engine of a motor vehicle.

More particularly, the technical field relates to a method for evaluating an exhaust gas temperature at an inlet of a turbocharger turbine located in the exhaust pipe.

### BACKGROUND

It is known that an internal combustion engine conventionally comprises an engine block including a plurality of cylinders, each of which accommodates a reciprocating piston and is closed by a cylinder head that cooperates with the piston to define a combustion chamber. The pistons are mechanically coupled to an engine crankshaft, so that a reciprocating movement of each piston, due to the combustion of the fuel in the corresponding combustion chamber, is converted into a rotation of the engine crankshaft.

In order to operate, the internal combustion engine is further provided with an intake system for feeding fresh air into the combustion chambers, with a fuel injection system for feeding metered fuel quantities in the combustion chambers, and with an exhaust system for discharging exhaust gas from the combustion chambers after the fuel combustion.

The intake system generally comprises an intake pipe leading the fresh air from the environment into an intake manifold. The intake manifold comprises a plurality of branches, each of which is connected with a respective engine cylinder via one or more respective intake ports.

The fuel injection system generally comprises a plurality of fuel injectors, which are connected to a fuel tank via a fuel pump and which are operated by an engine control unit (ECU) according to a predetermined injection strategy.

The injection strategy essentially provides for the ECU to sense a position of an accelerator pedal or other accelerator device actuated by the user (driver), to use this accelerator position and possibly other suitable inputs for determining a requested value of the fuel quantity to be injected in an engine cylinder during an engine cycle, and to operate the fuel injector accordingly.

Eventually the exhaust system comprises an exhaust manifold having a plurality of branches, each of which is connected with a respective engine cylinder via one or more respective exhaust ports, and an exhaust pipe leading the exhaust gas from the exhaust manifold to the environment.

One or more aftertreatment devices, typically catalytic aftertreatment devices such as a Diesel Oxidation Catalyst (DOC) and others, are usually located in the exhaust pipe to reduce the pollutant emissions of the internal combustion engine.

Most internal combustion engines are currently provided also with a turbocharger having the function of increasing the pressure of the fresh air entering the engine cylinders, in order to enhance the engine torque and decrease the fuel consumption.

The turbocharger conventionally comprises a compressor located in the intake pipe, which is mechanically driven by a turbine located in the exhaust pipe upstream the aftertreatment devices.

As a matter of fact, the turbocharger turbine comprises a turbine wheel, which is provided with a plurality of vanes and which is connected to the compressor wheel through a rigid shaft. The exhaust gas flowing in the exhaust pipe acts on the turbine vanes, so that the turbine wheel rotates and imparts rotational movement also to the compressor wheel.

Due to this structure, the turbocharger turbine is an engine component that is particularly affected by the temperature of the exhaust gases flowing therein.

For example, if the exhaust gases are too hot, the outer ends of the turbine vanes, where the material is thinnest, can become incandescent and melt. As a consequence, the turbine wheel becomes unbalanced, causing a fast wear of the bearings supporting the turbocharger shaft. In its turn, the wear of the bearings can cause the turbocharger shaft to seize up, thereby provoking great damages on both the turbine and the compressor wheels. Excessive exhaust gas temperatures can also erode or crack the turbine housing, in which the turbine wheel is accommodated. In extreme cases, the additional heat energy provided by too hot exhaust gases can drive the turbocharger into an over-speed condition, which exceeds the designed operating speed, so that the turbine wheel or the compressor wheel may even burst.

Besides, the turbocharger turbine is not the only engine component to be affected by the exhaust gas temperature.

For example, an excessive exhaust gas temperature maintained for too long can damage the engine pistons. Such damages can include piston deformation, melting, burning, holes, cracking, etc.

On the other side, the exhaust gas temperature is an index of the engine performances: the higher the exhaust gas temperature the more is the power generated by the engine. Therefore, it is generally advisable to operate the internal combustion engine so as to reach the higher value of the exhaust gas temperature allowed by the structural limit of the turbocharger turbine and of the other engine components affected thereby.

The exhaust gas temperature influences also the efficiency of the aftertreatment devices, because the performance of a catalytic aftertreatment device is generally considerably enhanced if it operates at temperatures where its conversion efficiency is maximized, whereas temperature too low or too high will result in poor performance and/or physical damages.

For these and other reasons, the ECU is generally provided for controlling the exhaust gas temperature during the operation of the internal combustion engine.

As a matter of fact, the ECU monitors a value of the exhaust gas temperature in a predetermined position along the exhaust pipe, typically at the inlet of the turbocharger turbine, and possibly adjusts the exhaust gas temperature, for example by operating the fuel injection system so as to modify the air-to-fuel ratio in the combustion chambers, if the monitored value of the exhaust gas temperature is outside a predetermined range of allowable values thereof.

For this control strategy to be effective, it is therefore essential to achieve a great accuracy in the determination of the value of the exhaust gas temperature.

At present, the determination of the exhaust temperature value is effected through a temperature sensor, which is located in the exhaust pipe, upstream or downstream of the turbocharger turbine, and which is in communication with the ECU.

This sensor can be an analog temperature sensor, for example a positive thermal coefficient (PTC) thermistor or a negative thermal coefficient (NTC) thermistor, or it can be a digital temperature sensor, for example a thermocouple.

Even if these temperature sensors are widely used, they are generally characterized by a long response time (i.e. the time needed by the sensor to sense a temperature variation), which strongly worsens the accuracy of the temperature measurement, especially when the internal combustion engine operates under a fast transient condition, so that the control strategy of the exhaust gas temperature is not always effective.

As a consequence, in order to be sure to protect the turbocharger turbine and the aftertreatment devices against damages, it is generally necessary to limit the range of the allowable values of the exhaust gas temperature, with the side effect of reducing the maximum performance of the internal combustion engine.

In view of the above, it is at least one object of an embodiment herein to provide a strategy for evaluating the exhaust gas temperature in a predetermined position along the exhaust pipe, typically at the turbine inlet, with a great accuracy either under steady state or transient engine operating conditions.

Another object is to achieve this goal with a simple, rational and rather inexpensive solution. In addition, other objects, desirable features and characteristics will become apparent from the subsequent summary and detailed description, and the appended claims, taken in conjunction with the accompanying drawings and this background.

### SUMMARY

In accordance with an embodiment, a method for determining a value of an exhaust gas temperature in a predetermined position along an exhaust pipe of an internal combustion engine, typically at an inlet of a turbine of a turbocharger, is provided. The method comprises the steps of:
measuring a value of an exhaust gas temperature in the exhaust pipe with a temperature sensor,
measuring a value of a pressure within a cylinder of the internal combustion engine with a pressure sensor,
estimating a value of an exhaust gas temperature in the exhaust pipe on the basis of the measured pressure value,
detecting whether the internal combustion engine is operating under a transient condition or not,
determining the value of the exhaust gas temperature in the predetermined position on the basis of the measured exhaust gas temperature value, if the transient condition is not detected,
   otherwise:
determining the value of the exhaust gas temperature in the predetermined position on the basis of the estimated exhaust gas temperature value.

Thanks to this solution, the exhaust gas temperature in the predetermined position can be evaluated with sufficient accuracy either if the internal combustion engine is operating under a transient condition or if the internal combustion engine is operating under a not-transient condition, namely under a steady state condition.

In fact, if the internal combustion engine is operating under a steady state condition, the temperature of the exhaust gas is expected not to be subjected to great variations, so that it is more reliably and accurately evaluated through the direct measurement made with a temperature sensor, because in this case the relatively long response time of the temperature sensor does not affect the measurement.

If conversely the internal combustion engine is operating under a transient condition, the temperature of the exhaust gas is expected to vary too fast for the response time of the temperature sensor. In this regard, the exhaust gas temperature in the predetermined position is more reliably and accurately evaluated through an estimation based on a value of pressure within the engine cylinder, which is accurately measured by means of the in-cylinder pressure sensor that has a response time much faster than that of a temperature sensor, because the in-cylinder pressure changes instantaneously with the driver/pedal request.

According to an embodiment, the detection of the transient condition comprises the steps of:
monitoring a value of a variation over the time of an engine operating parameter related to an engine torque, typically a requested quantity of fuel to be injected during an engine cycle,
identifying the transient condition if the monitored value of the variation over the time of the engine operating parameter exceeds a predetermined threshold value thereof.

Provided that the threshold value of the engine operating parameter is properly calibrated, this embodiment provides a reliable criterion for establishing whether the engine is operating under the transient condition or not.

In order to increase the robustness of the criterion, an embodiment provides that the detection of the transient condition comprises the additional step of monitoring a value of a variation over the time of a position of an accelerator of the internal combustion engine, typically an accelerator pedal; the transient condition being identified if also the monitored value of the variation over the time of the accelerator position exceeds a predetermined threshold value thereof.

Provided that the threshold value of the accelerator position is properly calibrated, this embodiment increases the robustness of the detection of the transient condition.

According to still another embodiment, the determination of the value of the exhaust gas temperature in the predetermined position on the basis of the estimated exhaust gas temperature value comprises the steps of:
calculating a difference between the estimated value of the exhaust gas temperature and a value of the exhaust gas temperature estimated in a previous engine cycle,
calculating the value of the exhaust gas temperature in the predetermined position as a sum of the difference and a value of the exhaust gas temperature in the predetermined position determined in the previous engine cycle.

According to this embodiment, each exhaust gas temperature value that is determined through the pressure-based estimation is always calculated on the basis of the preceding one. As a consequence, the first exhaust temperature value that is determined through the pressure-based estimation, after the detection of the transient condition, is calculated on the basis of the last measured value, and the accuracy of the evaluation of the exhaust gas temperature is therefore increased.

The methods according to the embodiments can be carried out with the help of a computer program comprising a program-code for carrying out all the steps of the methods described above, and in the form of a computer program product comprising the computer program.

The computer program product can be embodied as an internal combustion engine comprising an exhaust pipe, an ECU, a data carrier associated to the ECU, and the computer program stored in the data carrier, so that, when the ECU executes the computer program, all the steps of the method described above are carried out.

The method can be also embodied as an electromagnetic signal, the signal being modulated to carry a sequence of data bits which represent a computer program to carry out all steps of the method.

Another embodiment provides an apparatus for determining a value of an exhaust gas temperature in a predetermined position along an exhaust pipe of an internal combustion engine, typically at an inlet of a turbine of a turbocharger, wherein the apparatus comprises:
a temperature sensor for measuring a value of an exhaust gas temperature in the exhaust pipe,
a pressure sensor for measuring a value of a pressure within a cylinder of the internal combustion engine,
means for estimating a value of an exhaust gas temperature in the exhaust pipe on the basis of the measured pressure value,
means for detecting whether the internal combustion engine is operating under a transient condition or not,
means for determining the value of the exhaust gas temperature in the predetermined position on the basis of the measured exhaust gas temperature value, if the transient condition is not detected, and
means for determining the value of the exhaust gas temperature in the predetermined position on the basis of the estimated exhaust gas temperature value, if the transient condition is detected.

This embodiment, as the various embodiments described above, allows for a reliable evaluation of the exhaust gas temperature either if the internal combustion engine is operating under a transient condition or if the internal combustion engine is operating under a steady state condition.

Still another embodiment provides an automotive system comprising: an internal combustion engine (ICE), an exhaust pipe, a temperature sensor located in the exhaust pipe, at least a pressure sensor located in a cylinder of the internal combustion engine, and an electronic control unit (ECU) in communication with the temperature sensor and with the pressure sensor, wherein the ECU is configured to:
measure a value of an exhaust gas temperature in the exhaust pipe with the temperature sensor,
measure a value of a pressure within a cylinder of the internal combustion engine with the pressure sensor,
estimate a value of an exhaust gas temperature in the exhaust pipe on the basis of the measured pressure value,
detect whether the internal combustion engine is operating under a transient condition or not,
determine the value of the exhaust gas temperature in the predetermined position on the basis of the measured exhaust gas temperature value, if the transient condition is not detected,
   otherwise:
determine the value of the exhaust gas temperature in the predetermined position on the basis of the estimated exhaust gas temperature value.

Also this embodiment allows for a reliable evaluation of the exhaust gas temperature either if the internal combustion engine is operating under a transient condition or if the internal combustion engine is operating under a steady state condition

### BRIEF DESCRIPTION OF THE DRAWINGS

The various embodiments will hereinafter be described in conjunction with the following drawing figures, wherein like numerals denote like elements, and wherein:

FIG. 1 is a top view schematic showing an automotive system;

FIG. 2 is a section of an internal combustion engine belonging to the automotive system of FIG. 1; and

FIG. 3 is a flowchart of a method for determining a value of an exhaust gas temperature in a predetermined position along the exhaust pipe of the automotive system of FIG. 1, according to an embodiment.

### DETAILED DESCRIPTION

The following detailed description is merely exemplary in nature and is not intended to limit the various embodiments or the application and uses thereof. Furthermore, there is no intention to be bound by any theory presented in the preceding background or the following detailed description.

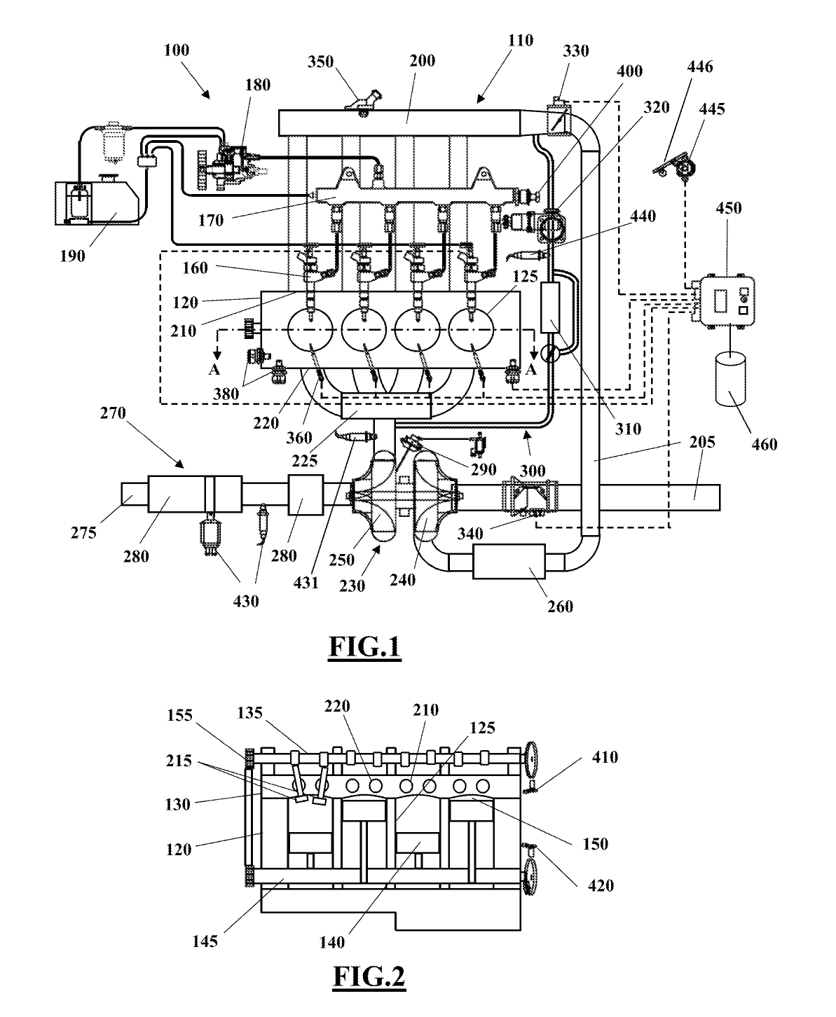

Some embodiments may include an automotive system 100, as shown in FIGS. 1 and 2, that includes an internal combustion engine (ICE) 110, in this example a Diesel engine, having an engine block 120 defining one or more cylinder 125 having a piston 140 coupled to rotate a crankshaft 145. A cylinder head 130 cooperates with the piston 140 to define a combustion chamber 150. A fuel and air mixture (not shown) is disposed in the combustion chamber 150 and ignited, resulting in hot expanding exhaust gasses causing reciprocal movement of the piston 140. The fuel is provided by one or more fuel injector 160 and the air through at least one intake port 210. The fuel is provided at high pressure to the fuel injector 160 from a fuel rail 170 in fluid communication with a high pressure fuel pump 180 that increases the pressure of the fuel received from a fuel source 190. Each of the cylinders 125 has at least two valves 215, actuated by a camshaft 135 rotating in time with the crankshaft 145. The valves 215 selectively allow air into the combustion chamber 150 from the port 210 and alternately allow exhaust gases to exit through a port 220. In some examples, a cam phaser 155 may selectively vary the timing between the camshaft 135 and the crankshaft 145.

More precisely, each combustion chamber 150 is provided for cyclically performing an engine cycle. In this example, each engine cycle involves two complete rotations of the crankshaft 145, which correspond to four strokes of the piston 140 in the related cylinder 125, including an intake stroke, in which the valves 215 allows air into the combustion chamber 150, a compression stroke, in which the valves 215 are closed allowing the piston to compress the air in the combustion chamber 150, an expansion stroke, in which the valves 215 are still closed and the piston moves due to the gas expansion, and an exhaust stroke, in which the valves 215 allow exhaust gases to exit the combustion chamber 150. The fuel is injected in the combustion chamber 150 nearly at the end of the compression stroke.

In this example, the ICE 110 comprises four combustion chambers 150, each of which is provided for cyclically operating an engine cycle as explained above. The engine cycles operated in each of this combustion chambers 150 are staggered over the time with respect of the engine cycles operated in the other combustion chambers 150, so that each phase of the engine cycle, such as for example the fuel injection and combustion phase, occurs in the different combustion chambers 150 at different times. As a result, the ICE 110 globally performs engine cycles in sequence, wherein the last engine cycle of the sequence is always performed in a different combustion chamber 150 than the previous engine cycle, and so forth.

The air may be distributed to the air intake port(s) 210 through an intake manifold 200. An air intake duct 205 may provide air from the ambient environment to the intake manifold 200. In other embodiments, a throttle body 330 may be provided to regulate the flow of air into the manifold 200. The exhaust gases exit the exhaust port(s) 220 and are directed into an exhaust system 270.

The exhaust system 270 may include an exhaust manifold 225 that directs exhaust gases from the exhaust ports 220 to an exhaust pipe 275 having one or more exhaust aftertreatment devices 280. The aftertreatment devices 280 may be any device configured to change the composition of the exhaust gases. Some examples of aftertreatment devices 280 include, but are not limited to, catalytic converters (two and three way), oxidation catalysts, lean NOx traps, hydrocarbon adsorbers, selective catalytic reduction (SCR) systems, and particulate filters. Other embodiments may include an exhaust gas recirculation (EGR) system 300 coupled between the exhaust manifold 225 and the intake manifold 200. The EGR system 300 may include an EGR cooler 310 to reduce the temperature of the exhaust gases in the EGR system 300. An EGR valve 320 regulates a flow of exhaust gases in the EGR system 300.

In some embodiments, a forced air system such as a turbocharger 230, having a compressor 240 rotationally coupled to a turbine 250, may be provided. Rotation of the compressor 240 increases the pressure and temperature of the air in the duct 205 and manifold 200. An intercooler 260 disposed in the duct 205 may reduce the temperature of the air. The turbine 250 is located in the exhaust pipe 275 upstream the aftertreatment devices 280, and rotates by receiving exhaust gases from the exhaust manifold 225 that directs exhaust gases from the exhaust ports 220 and through a series of vanes prior to expansion through the turbine 250. This example shows a variable geometry turbine (VGT) with a VGT actuator 290 arranged to move the vanes to alter the flow of the exhaust gases through the turbine 250. In other embodiments, the turbocharger 230 may be fixed geometry and/or include a waste gate.

The automotive system 100 may further include an electronic control unit (ECU) 450 in communication with one or more sensors and/or devices associated with the ICE 110. The ECU 450 may receive input signals from various sensors configured to generate the signals in proportion to various physical parameters associated with the ICE 110. The sensors include, but are not limited to, a mass airflow and temperature sensor 340, a manifold pressure and temperature sensor 350, an in-cylinder or combustion pressure sensor 360, coolant and oil temperature and level sensors 380, a fuel rail pressure sensor 400, a cam position sensor 410, a crank position sensor 420, exhaust pressure and temperature 430, an EGR temperature sensor 440, and a wide range position sensor 445 of an accelerator pedal 446. Furthermore, the ECU 450 may generate output signals to various control devices that are arranged to control the operation of the ICE 110, including, but not limited to, the fuel injectors 160, the throttle body 330, the EGR Valve 320, the VGT actuator 290, and the cam phaser 155. Note, dashed lines are used to indicate communication between the ECU 450 and the various sensors and devices, but some are omitted for clarity.

In this example, the sensors further include an additional exhaust temperature sensor 431, which is provided for measuring the exhaust gas temperature at the inlet of the turbine 250. The additional temperature sensor 431 is located in the exhaust pipe 275 between the exhaust manifold 225 and the turbine 250, and it is in communication with the ECU 450 to which it directs signals in proportion to the exhaust gas temperature, for analysis and processing. In other embodiments, the additional temperature sensor 431 can be located immediately downstream the turbine 250. In this case, the ECU 450 is properly configured for calculating the exhaust gas temperature at the turbine inlet as a function of the exhaust temperature at the turbine outlet.

The additional temperature sensor 431 can be an analog sensor or a digital sensor.

An analog sensor can be basically considered as a resistance that changes with the temperature. The analog sensor receives as input an electrical current and returns as output an analog voltage tension, whose value changes as a function of the value of the resistance and thus of the value of the temperature. In this way, the sensor output is an analog electric signal and the ECU 450 receives this analog signal through an analog interface; then an analog to digital conversion is performed internally the ECU 450. With this technology, the accuracy/performance of the signal acquisition depends primarily from the interface characteristics and from the analog to digital converter.

A digital sensor is structurally similar to the analog sensor but it returns as output a digital voltage signal. This digital electric signal is driven to the ECU 450 through the LIN/CAN interface that is a serial standard communication protocol. In this way, the ECU 450 does not introduce any errors due to the analog to digital conversion and, in general, this technology has better accuracy/response time.

Turning now to the ECU 450, this apparatus may include a digital central processing unit (CPU) in communication with a memory system 460 and an interface bus. The CPU is configured to execute instructions stored as a program in the memory system 460, and send and receive signals to/from the interface bus. The memory system 460 may include various storage types including optical storage, magnetic storage, solid state storage, and other non-volatile memory. The interface bus may be configured to send, receive, and modulate analog and/or digital signals to/from the various sensors and control devices. The program may embody the methods disclosed herein, allowing the CPU to carryout out the steps of such methods and control the ICE 110.

In particular, the ECU 450 is configured to determine the requested quantity of fuel to be injected during each engine cycle and to operate the fuel injectors 160 accordingly.

More precisely, since the engine cycles are operated in sequence and each time in different combustion chambers 150, the ECU 450 is configured to cyclically determine the requested quantity of fuel to be injected during the last engine cycle of the sequence, and to operate the fuel injector 160 of the related combustion chamber 150 accordingly.

In order to accomplish this task, the ECU 450 determines a requested value of engine torque to be generated in the last engine cycle, typically on the basis of the current position of the accelerator pedal 446 as provided by the sensor 445. More particularly, the ECU 450 generally uses the measured position of the accelerator pedal 446 as input of a calibrated map which returns as output a correspondent engine torque requested value. The determined engine torque requested value is then applied to another calibrated map that returns a requested value of a quantity of fuel to be injected during the engine cycle. As a matter of fact, this fuel quantity requested value corresponds to the fuel quantity that is expected to achieve the requested value of engine torque, if the ICE 110 operates in ideal conditions. The fuel quantity requested value can eventually be corrected by the ECU 450 according to specific control strategies of other engine components and/or functions, such as for example the control strategies of the aftertreatment devices regeneration phases.

The fuel quantity injected during an engine cycle determines the air to fuel ratio of the fuel and air mixture in the combustion chamber 150, which directly affects the exhaust gas temperature. In a Diesel engine, the richer is the air to fuel ratio, the higher is the exhaust gas temperature.

In general, a too high exhaust gas temperature can have serious side effects. By way of example, it can causes engine damages, particularly to the turbine 250 of the turbocharger 230 and to the aftertreatment devices 280, and it can also worsen the efficiency of the aftertreatment devices 280.

For this and other reasons, the ECU 450 is configured for repeatedly determining (monitoring), during the operation of the ICE 110, a value EGT of the exhaust gas temperature in a predetermined position of the exhaust pipe 275, in this example at the inlet of the turbocharger turbine 250.

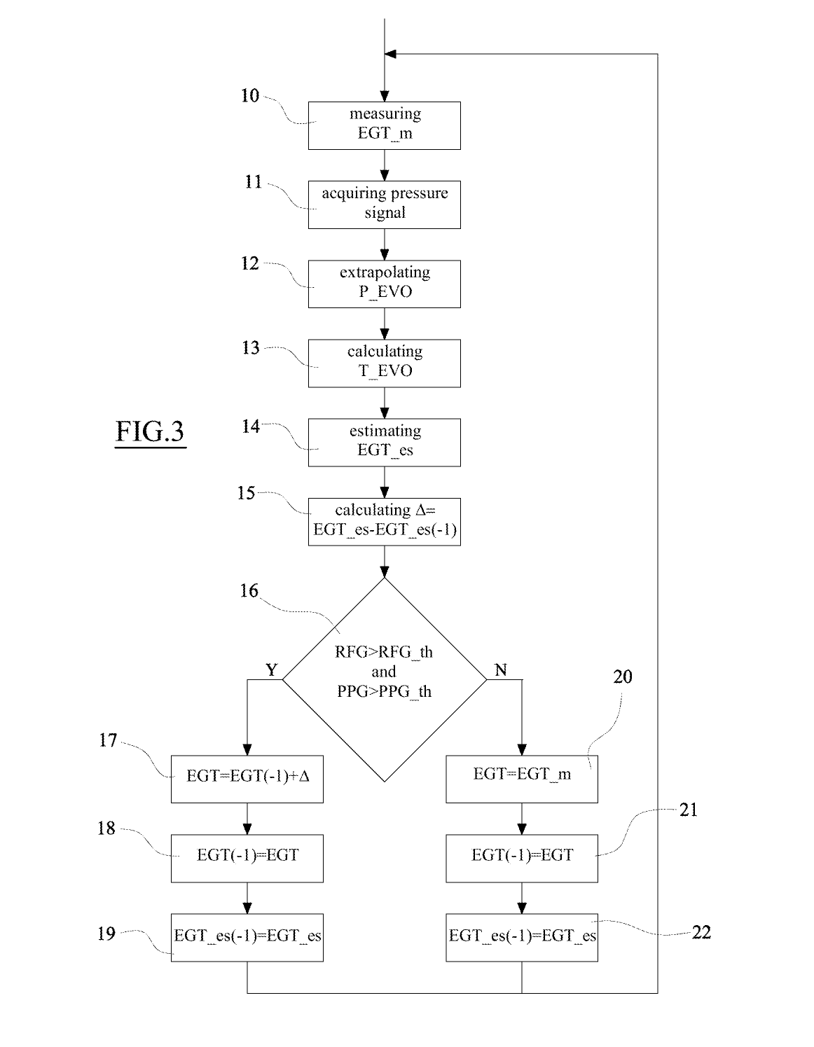

According to an embodiment, the ECU 450 determines the exhaust gas temperature value EGT once per engine cycle and each time with the routine represented in the flowchart of FIG. 3. Since the engine cycles are operated in sequence as explained above, this routine is always performed with reference to the last engine cycle of the sequence.

The routine firstly provides for the ECU 450 to measure a value EGT_m of the exhaust gas temperature through the additional exhaust temperature sensor 431 (block 10).

The routine further provides for the ECU 450 to acquire (block 11) the pressure signal generated by the in-cylinder pressure sensor 360 located in the cylinder 125 during the last engine cycle.

By means of known processing method, the ECU 450 extrapolates, from the acquired pressure signal, a value P_EVO of the pressure within the above mentioned cylinder 125, at the instant in which the respective exhaust port(s) 220 opened during the last engine cycle (block 12).

The measured in-cylinder pressure value P_EVO is then used by the ECU 450 for calculating (block 13) a value T_EVO of the temperature of the exhaust gas in the cylinder 125, at the instant in which the exhaust port(s) 220 opened. The temperature value T_EVO is calculated according to the equation of the ideal gas law:

PV=mRT.

In particular, the temperature value T_EVO is calculated with the equation:

$$T\_EVO = \frac{P\_EVO \cdot V}{m \cdot R}$$

wherein V is the value of the cylinder (combustion chamber) volume at the instant in which the exhaust port(s) 220 opened, m is the mass value of the gases trapped in that cylinder 125, and R is the specific gas constant. The volume value V can be calculated by the ECU 450 by implementing a known strategy based on the geometry of the ICE 110. The mass value m can be calculated by the ECU 450 as a sum of the air mass trapped in the cylinder 125, which can be measured through the mass air flow sensor 340, of the mass of the recirculated exhaust gas trapped in the cylinder 125, which is determined by the ECU 450 according to the EGR system control strategy, and of the fuel injected quantity, which has been determined by the ECU 450 in order to operate the fuel injector 160. The specific gas constant R is a coefficient that is stored in the memory system 460 in communication with the ECU 450.

The calculated temperature value T_EVO is then used by the ECU 450 for estimating (block 14) a value EGT_es of the exhaust gas temperature at the inlet of the turbocharger turbine 250, according to the following equation:

EGT_{—}es=T_{—}EVO·X·Y

wherein X is a value of a first correction factor depending on the engine load and Y is a value of a second correction factor depending on the engine speed. The value X of the first correction factor is determined by the ECU 450 by acquiring the actual value of the engine load and by using this value as input of a first map that correlates engine load values to corresponding values X of the first correction factor. Similarly, the value Y of the second correction factor is determined by the ECU 450 by acquiring the actual value of the engine speed and by using this value as input of a second map that correlates engine speed values to corresponding values Y of the second correction factor. The first map and the second map are determined during a calibration activity and are stored in the memory system 460 that is in communication with the ECU 450.

The ECU 450 then calculates (block 15) a value A of the difference between the exhaust gas temperature value EGT_es estimated in the last engine cycle and an exhaust gas temperature value EGT_es(−1) which was estimated by the routine during the very previous engine cycle and memorized in the memory system 460:

Δ=EGT_{—}es−EGT_{—}es(−1)

At this point, the routine provides for the ECU 450 to detect whether the ICE 110 is currently operating under a transient condition or not.

This detection is performed by considering the fuel injected quantities that have been requested during a predetermined number of engine cycles immediately preceding the detection itself These fuel quantity requested values can be read by the ECU 450 from the memory system 460, in which they have been stored. The fuel quantity requested values are then used by the ECU 450 for calculating a value RFG of a gradient, namely a variation over the time, of the requested fuel quantity. Contemporaneously, the ECU 450 determines a value PPG of a gradient, namely a variation over the time, of the position of the accelerator pedal 446 during the same time period in which the previously mentioned engines cycle have been performed. The values of the accelerator pedal position is measured by the sensor 445 and stored in the memory system 460.

The gradient values RFG and PPG are used as inputs of a decision block 16, in which the gradient value RFG is compared with a predetermined threshold value RFG_th of the fuel requested quantity gradient and the gradient value PPG is compared with a predetermined threshold value PPG_th of the pedal position gradient. The threshold values RFG_th and PPG_th are determined during a calibration activity so as to be representative of the boundary between the ICE 110 that operates under a transient condition, typically a fast transient condition, and the ICE 110 that does not operate under that transient condition. The threshold values RFG_th and PPG_th are stored in the memory system 460 in communication with the ECU 450.

If the gradient value RFG exceeds the threshold value RFG_th and if contemporaneously the gradient value PPG_th exceeds the threshold value PPG_th, then the decision block 16 identifies that the ICE 110 is operating under the transient condition, otherwise the decision block 16 identifies that the ICE 110 is not operating under the transient condition, namely that the ICE 110 is operating under a steady state condition.

If the decision block 16 returns that the ICE 110 is operating under the transient condition, then the ECU 450 determines (block 17) the value EGT of the exhaust gas temperature at the turbine inlet on the basis of the estimated value EGT_es.

More specifically, the ECU 450 calculates the value EGT for the last engine cycle as the sum between the previously calculated value A and a value EGT(−1) that was determined by the routine during the very previous engine cycle and memorized in the memory system 460:

EGT=EGT(−1)+Δ.

Once the exhaust gas temperature value EGT has been so determined, the ECU 450 updates the value EGT(−1) to the new determined value EGT (block 18) and the value EGT_es(−1) to the new estimated value EGT_es (block 19), before repeating the routine for the next engine cycle.

If conversely the decision block 16 identifies that the ICE 110 is not operating under the transient condition, then the ECU 450 determines (block 20) the value EGT of the exhaust gas temperature at the turbine inlet on the basis of the value EGT_m measured by the additional temperature sensor 431.

In the present example, since the additional temperature sensor 431 is located at the inlet of the turbine 250, the ECU 450 simply assumes the measured value EGT_m as the value EGT, according to the following equation:

EGT=EGT_m.

If the additional temperature sensor 431 was located downstream the turbine 250, the ECU 450 would calculate the value EGT as a function of the measured value EGT_m. The function correlating the exhaust gas temperature at the turbine inlet and the exhaust gas temperature at the turbine outlet is definite and determinable with a calibration activity.

Also in this case, once the exhaust gas temperature value EGT has been determined, the ECU 450 updates the value EGT(−1) to the new determined value EGT (block 21) and the value EGT_es(−1) to the new estimated value EGT_es (block 22), before repeating the routine for the next engine cycle.

It should be understood that, before performing the above described routine for the first time, namely for the first engine cycle after the start of the ICE 110, both the value EGT(−1) and the value EGT_es(−1) should be initialized to zero.

Thanks to this strategy, the value EGT of the exhaust gas temperature at the turbine inlet is monitored with sufficient accuracy either if the ICE 110 is operating under a transient condition or if the ICE 110 is operating under a not-transient condition, namely under a steady state condition. In fact, it has been found that, if ICE 110 is operating under a steady state condition, the temperature of the exhaust gas at the turbine inlet is more reliably and accurately evaluated through a direct measurement made with the additional temperature sensor 431, because in this case the relatively long response time of the temperature sensor 431 does not affect the measurement. If conversely the ICE 110 is operating under a transient condition, the temperature of the exhaust gas at the turbine inlet is more reliably and accurately evaluated through the estimation based on a value of pressure within the engine cylinder 125, which is accurately measured by means of the in-cylinder pressure sensor 360 that has a response time much faster than that of the temperature sensor 431, because the in-cylinder pressure changes instantaneously with the driver/pedal request.

The value EGT of the exhaust gas temperature at the turbine inlet is a useful parameter, which is involved in many of the ICE control strategies performed by the ECU 450, in order to obtain optimal turbocharger performance and to enhance the effectiveness of the aftertreatment devices 280.

By way of example, by controlling the exhaust gas temperature at the turbine inlet, the ECU 450 can:

improve the engine performances (typically in full load), allowing the ICE 110 to operate near the structural limit of the turbine 250, without damaging it;

optimize fuel consumption and reduce emissions during the regeneration phases of the aftertreatment devices 280, for instance by allowing the ICE 110 to use just enough fuel to raise the exhaust temperatures quickly but without consuming more fuel than needed.

In general, the ECU 450 can control the turbine inlet exhaust gas temperature by comparing the monitored value EGT of the exhaust gas temperature with a predetermined range of allowable values of the temperature at the turbine inlet. This range of values can be empirically calibrated with the aim of avoiding damages to the turbine 250 and/or to the aftertreatment devices 280 and/or of guaranteeing a high level of efficiency of the aftertreatment device 280. If the monitored value EGT falls outside the range of allowable values thereof, the ECU 450 can correct the requested quantities of fuel to inject in the engine cylinders 125, in order to bring the monitored value EGT back into the range.

Since the monitoring value EGT provided by the strategy explained above is accurate both during transient conditions and during steady state conditions, it follows that this monitoring strategy improves also the control of the exhaust temperature and therefore the benefits that this control achieves.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the forgoing summary and detailed description will provide those skilled in the art with a convenient road map for implementing at least one exemplary embodiment, it being understood that various changes may be made in the function and arrangement of elements described in an exemplary embodiment without departing from the scope as set forth in the appended claims and in their legal equivalents.

What is claimed is:

1. A method for determining a value of an exhaust gas temperature in a predetermined position along an exhaust pipe of an internal combustion engine, the method comprising the steps of:
measuring a value of the exhaust gas temperature in the exhaust pipe with a temperature sensor to obtain a measured exhaust gas temperature value;
measuring a value of a pressure within a cylinder of the internal combustion engine with a pressure sensor to obtain a measured pressure value;
estimating a value of the exhaust gas temperature in the exhaust pipe on a basis of to obtain an estimated exhaust gas temperature value;
detecting whether the internal combustion engine is operating under a transient condition or not;
determining the value of the exhaust gas temperature in the predetermined position on a basis of the measured exhaust gas temperature value, if the transient condition is not detected;
otherwise:
determining the value of the exhaust gas temperature in the predetermined position on the basis of the estimated exhaust gas temperature value.

2. The method according to claim 1, wherein detecting comprises the steps of:
monitoring a monitored value of a variation over a time of an engine operating parameter related to an engine torque,
identifying the transient condition if the monitored value of the variation over the time of the engine operating parameter exceeds a predetermined threshold value thereof.

3. The method according to claim 2, wherein detecting comprises additionally monitoring a value of a variation over the time of a position of an accelerator of the internal combustion engine, and wherein the transient condition is identified if also the value of the variation over the time of the position of the accelerator exceeds a predetermined threshold value thereof.

4. The method according to claim 1, wherein determining on the basis of the estimated exhaust gas temperature value comprises the steps of:
calculating a difference between the estimated exhaust gas temperature value and a value of the exhaust gas temperature estimated in a previous engine cycle,
calculating the value of the exhaust gas temperature in the predetermined position as a sum of the difference and a value of the exhaust gas temperature in the predetermined position determined in the previous engine cycle.

5. A computer program product comprising a non-transitory computer usable medium having a computer readable program code embodied therein, the computer readable program code adapted to be executed to implement a method for determining a value of an exhaust gas temperature in a predetermined position along an exhaust pipe of an internal combustion engine, the method comprising the steps of:
measuring a value of the exhaust gas temperature in the exhaust pipe with a temperature sensor to obtain a measured exhaust gas temperature value;
measuring a value of a pressure within a cylinder of the internal combustion engine with a pressure sensor to obtain a measured pressure value;
estimating a value of the exhaust gas temperature in the exhaust pipe on a basis of the measured pressure value to obtain an estimated exhaust gas temperature value;
detecting whether the internal combustion engine is operating under a transient condition or not;
determining the value of the exhaust gas temperature in the predetermined position on a basis of the measured exhaust gas temperature value, if the transient condition is not detected;
otherwise:
determining the value of the exhaust gas temperature in the predetermined position on the basis of the estimated exhaust gas temperature value.

6. The computer program product according to claim 5, wherein detecting comprises the steps of:
monitoring a monitored value of a variation over a time of an engine operating parameter related to an engine torque,
identifying the transient condition if the monitored value of the variation over the time of the engine operating parameter exceeds a predetermined threshold value thereof.

7. The computer program product according to claim 6, wherein detecting comprises additionally monitoring a value of a variation over the time of a position of an accelerator of the internal combustion engine, and wherein the transient condition is identified if also the value of the variation over the time of the position of the accelerator exceeds a predetermined threshold value thereof.

8. The computer program product according to claim 5, wherein determining on the basis of the estimated exhaust gas temperature value comprises the steps of:
calculating a difference between the estimated exhaust gas temperature value and a value of the exhaust gas temperature estimated in a previous engine cycle,
calculating the value of the exhaust gas temperature in the predetermined position as a sum of the difference and a value of the exhaust gas temperature in the predetermined position determined in the previous engine cycle.

9. An apparatus for determining a value of an exhaust gas temperature in a predetermined position along an exhaust pipe of an internal combustion engine, wherein the apparatus comprises:
a temperature sensor for measuring a value of the exhaust gas temperature in the exhaust pipe and for obtaining a measured exhaust gas temperature value;
a pressure sensor for measuring a value of a pressure within a cylinder of the internal combustion engine and for obtaining a measured pressure value;
a means for estimating a value of the exhaust gas temperature in the exhaust pipe on a basis of the measured pressure value to obtain an estimated exhaust gas temperature value;
a means for detecting whether the internal combustion engine is operating under a transient condition or not;
a means for determining the value of the exhaust gas temperature in the predetermined position on a basis of the measured exhaust gas temperature value, if the transient condition is not detected; and
a means for determining the value of the exhaust gas temperature in the predetermined position on the basis of the estimated exhaust gas temperature value, if the transient condition is detected.

10. An automotive system comprising:
an internal combustion engine, an exhaust pipe, a temperature sensor located in the exhaust pipe, a pressure sensor located in a cylinder of the internal combustion engine, and an electronic control unit (ECU) in communication with the temperature sensor and with the pressure sensor, wherein the ECU is configured to:
measure a value of an exhaust gas temperature in the exhaust pipe with the temperature sensor to obtain a measured exhaust gas temperature value;
measure a value of a pressure within the cylinder of the internal combustion engine with the pressure sensor to obtain a measured pressure value;
estimate a value of the exhaust gas temperature in the exhaust pipe on a basis of the measured pressure value to obtain an estimated exhaust gas temperature value;
detect whether the internal combustion engine is operating under a transient condition or not;
determine the value of the exhaust gas temperature in a predetermined position on a basis of the measured exhaust gas temperature value, if the transient condition is not detected;
otherwise:
determine the value of the exhaust gas temperature in the predetermined position on the basis of the estimated exhaust gas temperature value.

11. The automotive system according to claim 10, wherein during detecting the ECU is configured to:
monitor a monitored value of a variation over a time of an engine operating parameter related to an engine torque, and
identify the transient condition if the monitored value of the variation over the time of the engine operating parameter exceeds a predetermined threshold value thereof.

12. The automotive system according to claim 11, wherein during detecting the ECU is configured to additionally monitor a value of a variation over the time of a position of an accelerator of the internal combustion engine, and identify the transient condition if also the value of the variation over the time of the position of the accelerator exceeds a predetermined threshold value thereof.

13. The automotive system according to claim 10, wherein during determining on the basis of the estimated exhaust gas temperature value the ECU is configured to:
calculate a difference between the estimated exhaust gas temperature value and a value of the exhaust gas temperature estimated in a previous engine cycle, and
calculate the value of the exhaust gas temperature in the predetermined position as a sum of the difference and a value of the exhaust gas temperature in the predetermined position determined in the previous engine cycle.
